(19) United States
(12) Patent Application Publication
(10) Pub. No.: US 2004/0037609 A1
(43) Pub. Date: Feb. 26, 2004

(54) Stick-like object receiving member and barrel provided with stick-like object receiving member

(75) Inventor: Hidehei Kageyama, Kawagoe-shi (JP)

Correspondence Address: McGinn & Gibb, PLLC, Suite 200, 8321 Old Courthouse Road, Vienna, VA, 22182-3817, US

(73) Assignee: Kotobuki & Co., Ltd., Kyoto-shi (JP)

(21) Appl. No.: 10/642,198

(22) Filed: Aug. 18, 2003

(30) Foreign Application Priority Data
Aug. 23, 2002 (JP) 2002-244279

(51) Int. Cl. B43K 25/00

(52) U.S. Cl. 401/52; 401/49

(57) ABSTRACT

In a stick-like object receiving member having safety precautions, which receives a stick-lik object, a sufficient air passage is secured without exerting an influence on the size of the stick-like object or the receiving member. An eraser receiving member 16, which is the stick-like object receiving member, includes a cylindrical side portion 16b which engages with at least a part of the outer peripheral surface of an eraser 13, and surrounds at least a part of the outer peripheral surface of the eraser 13, and a bottom portion 16a which closes one end of the cylindrical side portion 16b. A slit 16e is formed in the cylindrical side portion 16b and bottom portion 16a so as to penetrate the cylindrical side portion 16b and bottom portion 16a in the axial direction, and the slit 16e serves as an air passage.

### BACKGROUND OF THE INVENTION

1. Field of the Invention

The present invention relates to a stick-like object receiving member used for a writing instrument etc. and, more particularly, to a stick-like object receiving member having safety precautions and a barrel provided with the stick-like object receiving member.

2. Description of the Related Art

As an example of a conventional stick-like object receiving member of this type, there is an eraser receiving member that is mounted in the end portion of a writing instrument to receive an eraser. This eraser receiving member can be removed from the body of the writing instrument as it is mounted detachably to the end portion of the writing instrument, and it is considerably smaller than the writing instrument as a whole in this state. Considering a case where the eraser receiving member or the writing instrument is swallowed inadvertently in a state in which the eraser receiving member is removed from the body of writing instrument or in a state in which the eraser receiving member is mounted, it is necessary to provid safety precautions to the eras r rec iving memb r to secure the airway.

As an eraser receiving member provided with such safety precautions, for example, a safety cap described in National Publication of International Patent Application No. 2001-504764 is known. The safety cap described in this Publication has a cylindrical hollow body, an eraser formed of a substantially solid material, which is accommodated in one end of the hollow body and has a portion extending beyond the end of the body, and an air passage disposed between the outer peripheral surface of the eraser and the inner peripheral surface of the body to secure the airway from one end of the body via the body. This air passage is created as a space formed between the inner peripheral surface of the body and the outer peripheral surface of the eraser by a plurality of protrusions formed on the inner peripheral surface of the body or by a plurality of protrusions formed on the outer peripheral surface of the eraser.

However, the safety cap described in this Publication utilizes the small protrusions formed on the inner peripheral surface of the body or on the outer peripheral surface of the eraser to form the air passage, and thus presents a problem in that only a very narrow gap is formed between the inner peripheral surface of the body and the outer peripheral surface of the eraser, which is not satisfactory for the air passage. In order to form a large air passage, the heights of protrusions must be increased. In this case, however, the outside diameter of eraser becomes small, so that the eraser itself must be made small. Maintaining the size of eraser makes it necessary to increase the inside diameter of body. This results in the increased size of body, and may adversely affect the design of writing instrument.

### SUMMARY OF THE INVENTION

The present invention has been made to solve the above problem, and accordingly an object thereof is to provide a stick-like object receiving member having safety precautions capable of securing a sufficient air passage without exerting an influence on the size of a stick-like object or a receiving member, and a barrel provided with the stick-like object receiving member.

To achieve the above object, a stick-like object receiving member with safety precautions for receiving a stick-like object according to the present invention, includes a cylindrical side portion which engages with at least a part of the outer peripheral surface of the stick-like object and surrounds at least a part of the outer peripheral surface of the stick-like object, and a bottom portion which closes one end of the cylindrical side portion. A slit is formed in the cylindrical side portion and bottom portion so as to pen trate the cylindrical side portion and bottom portion in the axial direction, and the slit serves as an air passage.

In a state in which the stick-like object engages with the cylindrical side portion, a portion in which the slit penetrating the cylindrical side portion and bottom portion in the axial direction is depressed to the inside diameter side as compared with the cylindrical side portion, and thus the slit serves as an air passage. Therefore, even if the stick-like object receiving member is swallowed, the airway can be secured by the air passage formed by the slit. The slit, which forms an air passage, is formed in the cylindrical side portion and the bottom portion. Since this configuration is different from a conventional configuration in which an air passage is formed between the inner peripheral surface of the cylindrical side portion and the outer peripheral surface of the stick-like object, the air passage can be formed and also the size of air passage can be adjusted without exerting an influence on the inside diameter of cylindrical side portion or the outside diameter of stick-like object.

A plurality of the slits can be formed at intervals in the circumferential direction. Thereby, a large cross-sectional area of air passage can be secured.

The cylindrical side portion can hav a collar portion protruding outward in the radial direction on the other end thereof.

Also, the present invention provides a barrel having the above-described stick-like object receiving member and a cylindrical casing in which the stick-like object receiving member is mounted detachably at one end thereof.

Further, a barrel, according to the present invention, having the stick-like object receiving member is provided with the cylindrical side portion having the collar portion and a cylindrical casing in which the stick-like object receiving member is mounted detachably at one end thereof. The barrel includes an end face to which the collar portion of the stick-like object receiving member is locked, an inner peripheral surface which engages with at least a part of the cylindrical side portion of the stick-like object receiving member other than the collar portion and surrounds the outer peripheral surface of the cylindrical side portion other than the collar portion, and a step portion formed on the inner peripheral surface so as to be separated from the bottom portion of the stick-like object receiving member. A gap formed between the step portion and the bottom portion communicates with the slit and forms an air passage together with the slit.

The present disclosur relates to subject matter contained in Japanese Patent Application No. 2002-244279, filed on Aug. 23, 2002, which is expressly incorporat d herein by reference in its entirety.

### BRIEF DESCRIPTION OF THE DRAWINGS

FIG. 1 is a longitudinal sectional view of a writing instrument provided with a stick-like object receiving member in accordance with the present invention;

FIG. 2A is a perspective view of a stick-like object and a stick-like object receiving member, and FIG. 2B is a perspective view showing a state in which the stick-like object is inserted in the stick-like object receiving member;

FIG. 3A is a side view of a stick-like object receiving member, FIG. 3B is a view taken in the direction of arrow 3b of FIG. 3A, and FIG. 3C is a sectional view taken along the line 3c-3c of FIG. 3A;

FIG. 4 is a partially sectional view of an essential portion showing a state in which a stick-like object receiving member is mounted in a knock casing; and

FIG. 5 is a view taken in the direction of arrow 5 of FIG. 4.

### DETAILED DESCRIPTION OF THE PREFERRED EMBODIMENTS

An embodiment of the present invention will now be described with reference to the accompanying drawings.

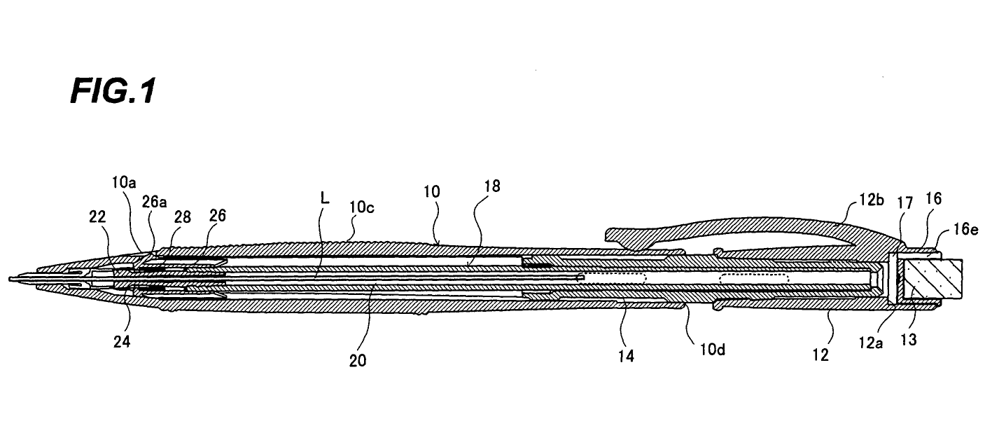

FIG. 1 is a longitudinal sectional view of a writing instrument provided with a stick-like object receiving member in accordance with the present invention. In this example, a mechanical pencil is taken as an example of writing instrument. However, the writing instrument is not limited to the mechanical pencil, and the present invention can be applied to any type of writing instrument such as ball-point pen, felt pen, fountain pen, and stylus pen. This mechanical pencil mainly has an external casing 10, a knock casing 12, and an intermediate casing 14, and a lead delivering mechanism 18 for delivering a lead is incorporated in the external casing 10. As publicly known, the lead delivering mechanism 18 includes a lead tank 20 for storing a lead L, a lead tightening chuck 22 whose rear end is pressed into the lead tank 20 and whose front end portion tightens the lead L, a chuck ring 24 which is disposed on the outer periphery side of the lead tightening chuck 22 to tighten the lead tightening chuck 22, a sleeve 26 for regulating the rearward movement of the chuck ring 24, and a chuck spring 28 interposed between the sleeve 26 and the front end of the lead tank 20 to always urge the lead tank 20 and the lead tightening chuck 22 rearward. An elastic blade portion 26a formed on the sleeve 26 is locked to an opening 10a formed in the external casing 10, by which the lead delivering mechanism 18 is held in the external casing 10.

Th rear end of the lead tank 20 protrudes and ext nds from a rear end opening 10d of the external casing 10 so as to be capable of accommodating a lead longer than the total length of the external casing 10. In an annular space between the inner peripheral surface at the rear of the external casing 10 and the outer peripheral surface at the rear of the lead tank 20, the tip end of the intermediate casing 14 is inserted, and is fitted in the annular space. The tip end of the intermediate casing 14 is connected to the lead tank 20. Also, the rear end of the intermediate casing 14 is connected to the knock casing 12. The connecting force between the intermediate casing 14 and the knock casing 12 is set so as to be weaker than the connecting force between intermediate casing 14 and the lead tank 20 so that the knock casing 12 is detachable from the intermediate casing l4. Thus, the knock casing 12 is detachable with respect to the intermediate casing 14 and the external casing 10.

The knock casing 12 is integrally formed with a clip 12b on the outside surface thereof. Also, at the rear end of the knock casing 12, an eraser receiving member 16, which is a stick-like object receiving member, for receiving an eraser 13, which is a stick-like object, is mounted detachably. The stick-like object is not limited to the eraser 13, and an arbitrary object such as an error-correcting stick, solid paste, and marker can be received by the stick-like object receiving member 16. The length in the axial direction of stick-like object need not necessarily be larger than the outside diamet r thereof, but the stick-like object is supposed to b solid so that air cannot flow freely therein.

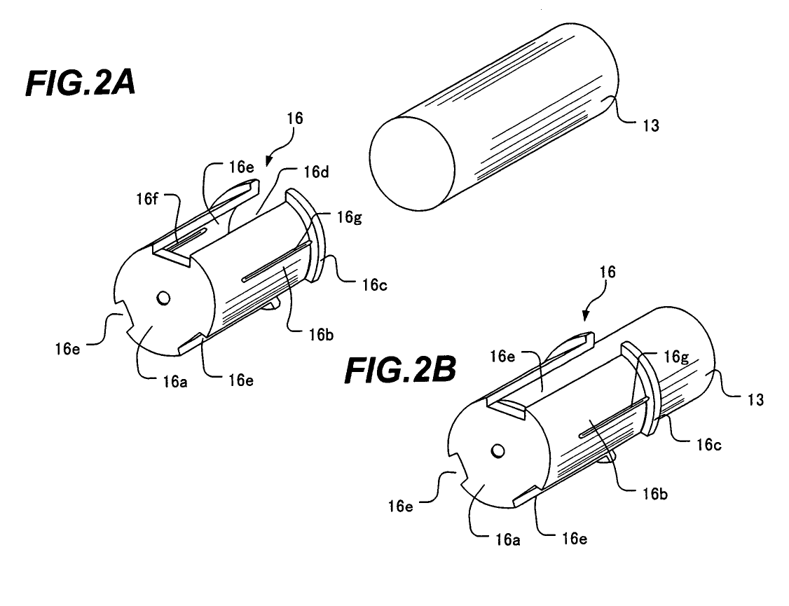

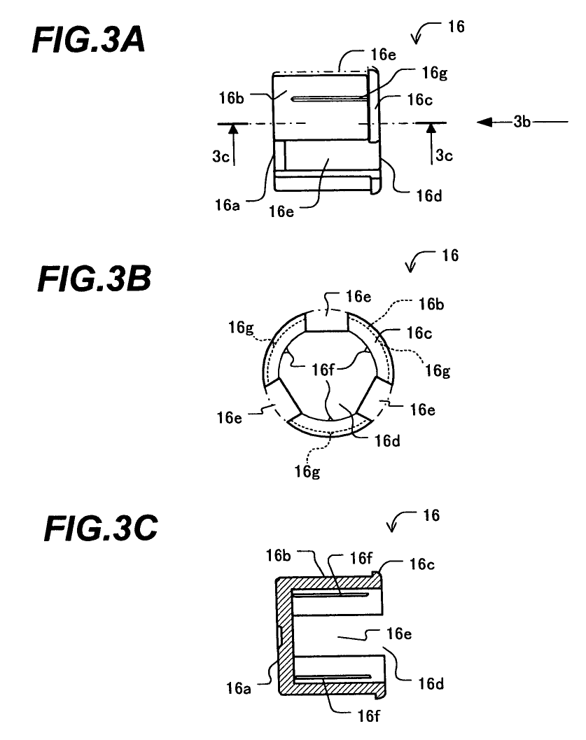

As shown in FIGS. 2 and 3, the eraser receiving member 16 has a bottom portion 16a for receiving the bottom surface of the eraser 13, a cylindrical side portion 16b which engages with a part of the outer peripheral surface of the eraser 13 and surrounds the part of the outer peripheral surface of the eraser 13, one end thereof being closed by the bottom portion 16a, and an opening portion 16d which opens at the other end of the cylindrical side portion 16b so as to face the bottom portion 16a. The eraser 13 protrudes from the eraser receiving member 16 through the opening portion 16d so that it can be used. The cylindrical side portion 16b has a collar portion 16c, which protrudes in the radial direction to be brought into contact with the rear end of the knock casing 12, on the side of opening portion 16d.

Furthermore, the eraser receiving member 16 is formed with a slit 16e which extends so as to penetrate the cylindrical side portion 16b and the bottom portion 16a in the axial direction to form an air passage. The number of the slits 16e can be made one. Also, as in the example shown in the figures, a plurality of (three in this example) slits 16e can be formed at intervals in the circumferential direction. The slit 16e need not necessarily extend in parallel with the axial dir ction, or n ed not extend straight.

Also, on the inner peripheral surface of the cylindrical side portion 16b of the eraser receiving member 16, ribs 16f for engagement with the eraser 13 are formed at appropriate places, and on the outer peripheral surface of the cylindrical side portion 16b, ribs 16g for engagement with the knock casing 12 are formed at appropriate places. By adjusting the height and number of the ribs 16f and 16g, the engagement forces between the eraser receiving member 16 and the engaging mating elements can be adjusted. The engagement force between the eraser receiving member 16 and the knock casing 12 is set so as to be larger than the engagement force between the eraser receiving member 16 and the eraser 13. The ribs 16f and 16g are ribs for engagement, and therefore the protrusion height thereof is relatively small. Therefore, a gap formed between the inner peripheral surface of the cylindrical side portion 16b of the eraser receiving member 16 and the outer peripheral surface of the eraser 13 by the rib 16f is very small even if it exists, so that the gap cannot serve as an air passage. Similarly, a gap formed between the outer peripheral surface of the cylindrical side portion 16b of the eraser receiving member 16 and the inner peripheral surface of the knock casing 12 by the rib 16g is very small even if it exists, so that the gap cannot serve as an air passage. When one end of th eraser 13 is inserted in the eraser r ceiving member 16 through the opening portion 16d, th outer peripheral surface of th one end portion engages with the inner peripheral surface of the cylindrical side portion 16b. When the eraser 13 has not be used yet, the eraser 13 is inserted to a position at which the bottom surface of the eraser 13 comes into contact with the bottom portion 16a of the eraser receiving member 16.

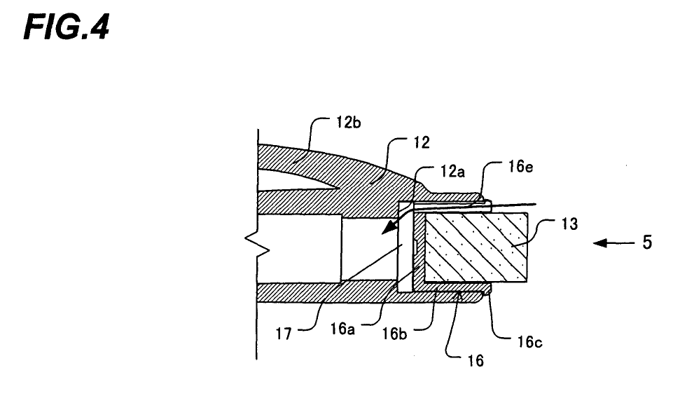

As shown in FIG. 4, when the eraser receiving member 16 is mounted in the knock casing 12, the collar portion 16c of the eraser receiving member 16 is locked to the rear end face of the knock casing 12, and the outer peripheral surface of the cylindrical side portion 16b other than the collar portion 16c engages with the inner peripheral surface of the rear end portion of the knock casing 12. At this time, the bottom portion 16a of the eraser receiving member 16 does not come into contact with the knock casing 12, and a gap 17 is formed between the bottom portion 16a of the eraser receiving member 16 and a step portion 12a formed on the inner peripheral surface of the knock casing 12.

In the eraser receiving member 16 constructed as described above, as shown in FIG. 2B, in the state in which the eraser receiving member 16 is removed from the knock casing 12, the portion of the slit 16e penetrates in the axial direction over the entire length of the eraser receiving member 16, and the portion of the slit 16e is depressed to the inside diamet r side as compared with the cylindrical side surface 16b, so that the slit 16 serves as an air passage. Therefore, even if the eras r receiving member 16 is swallowed and, for example, the collar portion 16c is caught by any portion, the airway can be secured by the air passage formed by the slit 16e.

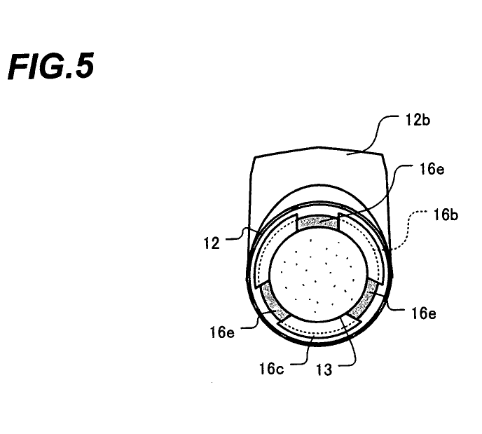

Also, as shown in FIG. 4, even in a state in which the eraser receiving member 16 is mounted in the knock casing 12 (a combination of the eraser receiving member 16 and the knock casing 12 in the state in which the eraser receiving member 16 is mounted in the knock casing 12 is referred to as a “barrel”), the portion of the slit 16e penetrates the eraser receiving member 16 in the axial direction, and the portion of the slit 16e is depressed to the inside diameter side as compared with the cylindrical side surface 16b to form a gap between the inner peripheral surface of the knock casing 12 and the eraser receiving member 16, so that the slit 16e serves as an air passage. In FIG. 5, the colored portions indicate air passages formed by the slits. 16e. Further, the gap 17 formed between the bottom portion 16a of the eraser receiving member 16 and the step portion 12a of the knock casing 12 serves as an air passage communicating with the air passage formed by the slit 16e. Therefore, even if the eraser receiving member 16 is swallowed together with the knock casing 12, the airway can be secured by the slit 16e and the gap 17.

As described above, according to the present invention, since the slit 16e formed so as to penetrate the cylindrical sid portion 16b and the bottom portion 16a of the eras r receiving member 16 is used as an air passag, the air passag does not at all affect the insid diameter of the raser receiving member 16 or the outside diameter of the eraser 13. Therefore, the eraser receiving member 16 and the eraser 13 can have a desired size. In addition, by setting the width, number, etc. of the slits 16e properly, the cross-sectional area of slits 16e colored in FIG. 5 can be adjusted arbitrarily, and thereby a cross-sectional area sufficient as an air passage can be secured.

While the principles of the invention have been described above in connection with specific embodiments, and particular modifications thereof, it is to be clearly understood that this description is made only by way of example and not as a limitation on the scope of invention.

What is claimed is:

1. A stick-lik object receiving member for receiving a stick-like object, comprising a cylindrical side portion which engages with at least a part of the outer peripheral surface of the stick-like object and surrounds at least a part of the outer peripheral surface of the stick-like object, and a bottom portion which closes one end of said cylindrical side portion, and the stick-like object receiving member having safety precautions, wherein
a slit is formed in said cylindrical side portion and bottom portion so as to penetrate said cylindrical side portion and bottom portion in the axial direction, to provide an air passage of the stick-like object receiving member.

2. The stick-like object receiving member according to claim 1, wherein a plurality of said slits are formed at intervals in the circumferential direction.

3. The stick-like object receiving member according to claim 1, wherein said cylindrical side portion has a collar portion protruding outward in the radial direction on the other end thereof.

4. The stick-like object receiving member according to claim 2, wherein said cylindrical side portion has a collar portion protruding outward in the radial direction on the other end thereof.

5. A barrel having the stick-like object r c iving member according to claim 1 and a cylindrical casing in which said stick-like object receiving memb r is mount d detachably at one end thereof.

6. A barrel having the stick-like object receiving member according to claim 2 and a cylindrical casing in which said stick-like object receiving member is mounted detachably at one end thereof.

7. A barrel having the stick-like object receiving member according to claim 3 and a cylindrical casing in which said stick-like object receiving member is mounted detachably at one end thereof.

8. A barrel having the stick-like object receiving member according to claim 3 and a cylindrical casing in which said stick-like object receiving member is mounted detachably at one end thereof, wherein
said barrel comprises an end face to which said collar portion of the stick-like object receiving member is locked; an inner peripheral surface which engages with at least a part of said cylindrical side portion of the stick-like object receiving member other than said collar portion and surrounds the outer peripheral surface of said cylindrical side portion other than said collar portion; and a step portion formed on said inner p ripheral surface so as to be separated from said bottom portion of the stick-like object receiving member, and a gap formed between said step portion and said bottom portion communicates with the slit and forms an air passage together with the slit.

9. A barrel having the stick-like object receiving member according to claim 4 and a cylindrical casing in which said stick-like object receiving member is mounted detachably at one end thereof, wherein
said barrel comprises an end face to which said collar portion of the stick-like object receiving member is locked; an inner peripheral surface which engages with at least a part of said cylindrical side portion of the stick-like object receiving member other than said collar portion and surrounds the outer peripheral surface of said cylindrical side portion other than said collar portion; and a step portion formed on said inner peripheral surface so as to be separated from said bottom portion of the stick-like object receiving member, and a gap formed between said step portion and said bottom portion communicates with the slit and forms an air passage together with the slit.
